(19) United States
(12) Patent Application Publication
(10) Pub. No.: US 2014/0025567 A1
(43) Pub. Date: Jan. 23, 2014

(54) PAYMENT SYSTEM PRE-SELECTION ENVIRONMENT PROCESSING

(71) Applicants: Mark Rigby, Rickmansworth (GB); Christian Aabye, Foster City, CA (US)

(72) Inventors: Mark Rigby, Rickmansworth (GB); Christian Aabye, Foster City, CA (US)

(21) Appl. No.: 13/947,984

(22) Filed: Jul. 22, 2013

Related U.S. Application Data
(60) Provisional application No. 61/674,082, filed on Jul. 20, 2012.

(51) Int. Cl. G06Q 20/26

(52) U.S. Cl. CPC G06Q 20/26
USPC 705/39

(57) ABSTRACT

Systems and methods for payment system pre-selection environment processing are provided. One such method comprises receiving payment information from a payment device from a consumer. The method further comprises executing a pre-selection phase to determine a preferred application identifier (AID) and routing option based on the payment information. The method also comprises completing a transaction using the preferred AID and routing option.

### CROSS-REFERENCES TO RELATED APPLICATIONS

This application is related to U.S. Provisional Patent Application No. 61/674,082, filed on Jul. 20, 2012, titled “PAYMENT SYSTEM PRE-SELECTION ENVIRONMENT PROCESSING,” by Mark Rigby and Christian Aabye, which is herein incorporated by reference in its entirety for all purposes.

### BACKGROUND

Traditionally, the use of particular payment networks for routing and processing of transactions has been determined by contractual arrangements between the payment networks and merchants or their acquirers. To support as many consumers as possible in the most commercially advantageous way, a merchant or acquirer may support transactions over many different payment networks. Each payment network may offer different features to consumers and merchants. A consumer's payment device may support several of the payment networks supported by a merchant. Generally, when a consumer initiates a transaction with a merchant, the consumer and merchant have limited control over which payment network the transaction is ultimately routed.

However, increasingly, there is a desire by both merchants and consumers to be more aware of, and exercise greater control over, how their transactions are routed. For example, a consumer may know that transactions routed over one network accrue rewards points to the consumer's account or provide security or other benefits. Similarly, merchants may be more aware of which networks offer faster, more reliable and/or cheaper transactions. At present, systems do not accommodate much control to merchants or consumers over the routing of their transactions.

Embodiments of the invention address this and other problems, individually and collectively.

### BRIEF SUMMARY

Systems and methods for payment system pre-selection environment processing are provided. One such method comprises receiving payment information from a payment device for a transaction at an access device. The access device can identify one or more routing options for the transaction based on the payment information. A preferred routing option can then be selected, and the transaction can be proceed using the application identifier (AID) and payment application associated with the selected routing option.

In one embodiment, a method for routing payment transactions can comprise receiving payment information from a contactless payment device from a consumer. The method can further comprise executing a pre-selection phase to determine a preferred AID and routing option based on the payment information. The method also comprises completing a transaction using the preferred AID and routing option.

In some embodiments, the pre-selection phase can include determining that the list of one or more application identifiers includes a single application identifier, and routing the transaction using a routing option corresponding to the single application identifier. Additionally, or alternatively, in some embodiments, the pre-selection phase can include reading a list of one or more application identifiers stored on the contactless payment device, and determining a priority for each of the one or more application identifiers. In some embodiments, the method can further include determining a highest priority application identifier, comparing the highest priority application identifier to a merchant list of supported application identifiers, and routing the transaction according to a routing option associated with the highest priority application identifier if the highest priority application identifier matches a preferred application identifier from the merchant list.

In one embodiment, an access device can include a processor, and a computer readable medium coupled to the processor. The access device can further include a merchant list of application identifiers stored on the computer readable medium, wherein the merchant list of application identifiers includes one or more application identifiers that correspond to routing options supported by a merchant. The access device can also include merchant routing preferences that define a priority associated with each of the one or more application identifiers. The access device can further include a contactless element, wherein when payment information is received from a contactless payment device, the processor is configured to execute a pre-selection phase to determine a preferred application identifier and routing option based on the payment information and the routing preferences, and complete a transaction using the preferred application identifier and routing option.

Embodiments of the present invention provide merchants and consumers with improved systems and methods of routing transactions according to merchant and consumer preferences. This can improve consumer experience, by enabling consumers to more easily take advantage of features and benefits provided by particular payment processing networks. Further, merchants can set preferences that select for commercially advantageous and/or more reliable payment processing networks. Transaction processing generally can be improved by setting preferences that select faster payment processing networks. By preferentially routing transactions over a larger variety of payment processing networks, message load over any one payment processing network may be reduced, generally improving performance. Additionally, by providing merchants and consumers with the ability to set routing preferences, competition can be fostered among payment processing networks for leading to improved reliability, lower cost, and more diverse features for merchants and consumers.

### BRIEF DESCRIPTION OF THE DRAWINGS

FIG. 1 shows a block diagram of a system according to some embodiments provided herein.

FIG. 2 shows a block diagram of an exemplary system comprising a server computer in accordance with some embodiments.

FIG. 3 shows an exemplary diagram of a financial transaction in accordance with some embodiments.

FIG. 4 shows a system for conducting payment transactions with multiple routing options in accordance with some embodiments.

FIG. 5 shows a method of performing a payment transaction with multiple routing options in accordance with some embodiments.

FIG. 6 shows a method of performing a payment transaction that invokes pre-selection processing in accordance with some embodiments.

FIG. 7 shows a method of performing pre-selection processing in accordance with some embodiments.

FIG. 8 shows an alternative method of performing pre-selection processing in accordance with some embodiments.

FIG. 9 shows an exemplary computer apparatus in accordance with some embodiments.

FIG. 10 shows an exemplary mobile device in accordance with some embodiments provided herein.

FIG. 11 shows an exemplary payment device in the form of card in accordance with some embodiments.

### DETAILED DESCRIPTION

The following disclosure may provide exemplary systems, devices, and methods for conducting a financial transaction and related activities. Although reference, may be made to such financial transactions in the examples provided below, embodiments are not so limited. That is, the systems, methods, and apparatuses described herein may be utilized for any suitable purpose.

Before discussing specific embodiments and examples, some descriptions of terms used herein are provided below.

As used herein, an “access device” may be any suitable device for communicating with a merchant computer or payment processing network, and for interacting with a payment device, a user computer apparatus, and/or a user mobile device. An access device may generally be located in any suitable location, such as at the location of a merchant. An access device may be in any suitable form. Some examples of access devices include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a payment device and/or a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device.

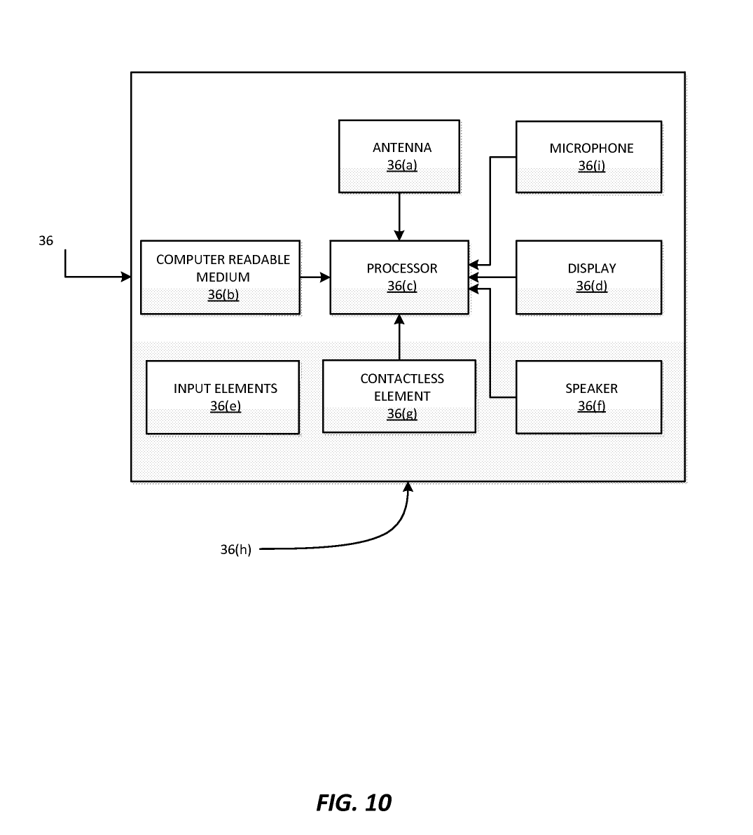

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below with reference to FIG. 10.

As used herein, a “payment account” (which may be associated with one or more payment devices) may refer to any suitable payment account including a credit card account, a checking account, or a prepaid account.

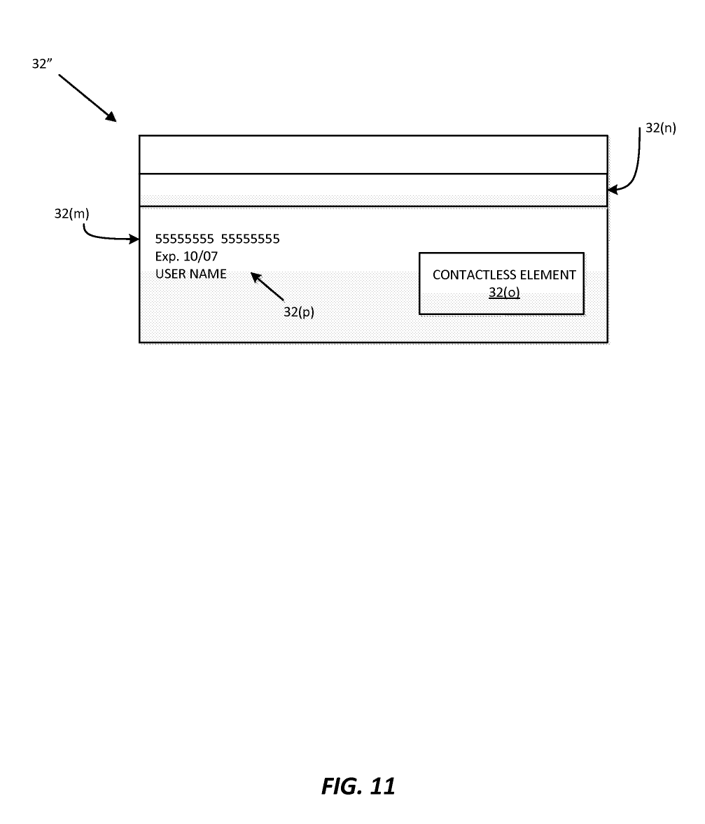

As used herein, a “payment device” may refer to any device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. An exemplary payment device is described below with reference to FIG. 11.

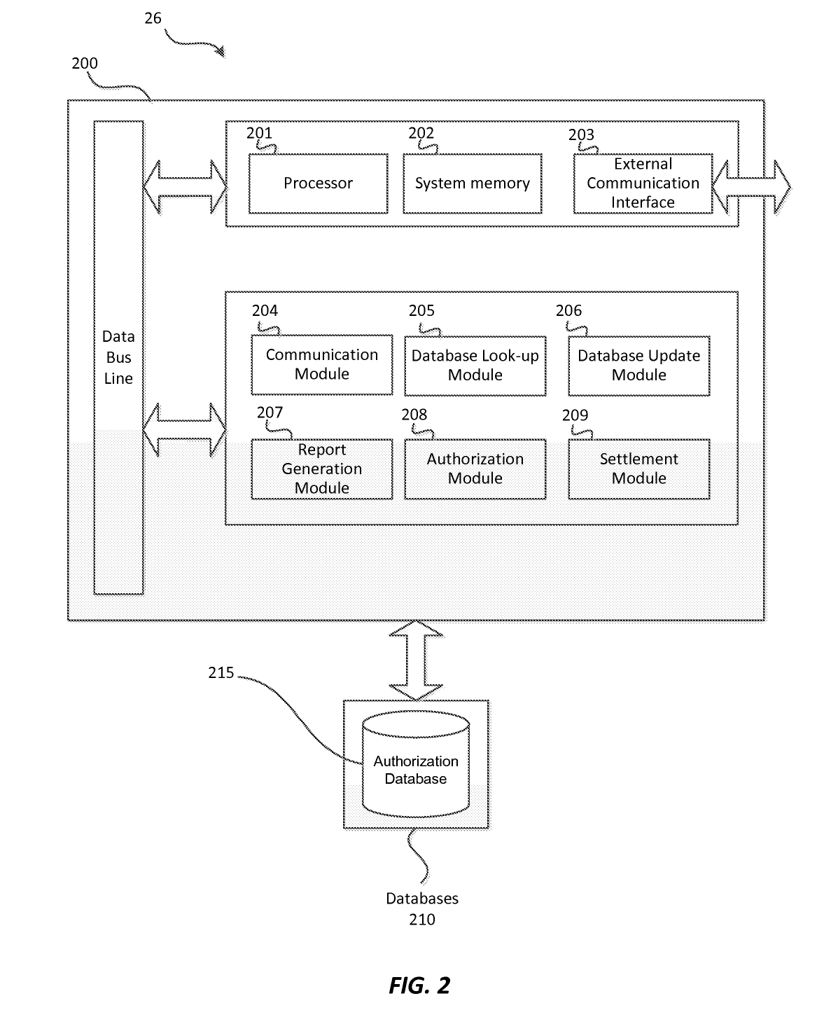

As used herein, a “server computer” is typically a powerful computer or cluster of computers. For example, the server computer can be a large mainframe, a minicomputer cluster, or a group of servers functioning as a unit. In one example, the server computer may be a database server coupled to a Web server. An example of a server computer is described with reference to a Payment Processing Network 26 in FIG. 2.

As used herein, “short range communication” or “short range wireless communication” may comprise any method of providing short-range contact or contactless communications capability, such as RFID, Bluetooth™, infra-red, or other data transfer capability that can be used to exchange data between a payment device and an access device. In some embodiments, short range communications may be in conformance with a standardized protocol or data transfer mechanism (e.g., ISO 14443/NFC). Short range communication typically comprises communications at a range of less than 2 meters. In some embodiments, it may be preferable to limit the range of short range communications (e.g. to a range of less than 1 meter, less than 10 centimeters, or less than 2.54 centimeters) for security, technical, and/or practical considerations. For instance, it may not be desirable for a POS terminal to communicate with every payment device that is within a 2 meter radius because each of those payment devices may not be involved in a transaction, or such communication may interfere with a current transaction involving different financial transaction devices. Typically the payment device or the access device also includes a protocol for determining resolution of collisions (i.e. when two payment devices are communicating with the access device simultaneously). The use of short range communications may be used when the merchant and the consumer are in close geographic proximity, such as when the consumer is at the merchant's place of business.

Provided below is a description of an exemplary system in which embodiments provided herein may be utilized. Although some of the entities and components may be depicted as separate, in some instances, one or more of the components may be combined into a single device or location (and vice versa). Similarly, although certain functionality may be described as being performed by a single entity or component within the system, the functionality may in some instances be performed by multiple components and/or entities (and vice versa). Communication between entities and components may comprise the exchange of data or information using electronic messages and any suitable electronic communication medium and method, as described below.

As used herein, an “issuer” may typically refer to a business entity (e.g., a bank or other financial institution) that maintains financial accounts for the user 30 and often issues a payment device 32 such as a credit or debit card to the user 30. As used herein, a “merchant” may typically refer to an entity that engages in transactions and can sell goods or services to the user 30. As used herein, an “acquirer” may typically refer to a business entity (e.g., a commercial bank or financial institution) that has a business relationship with a particular merchant or similar entity. Some entities can perform both issuer and acquirer functions.

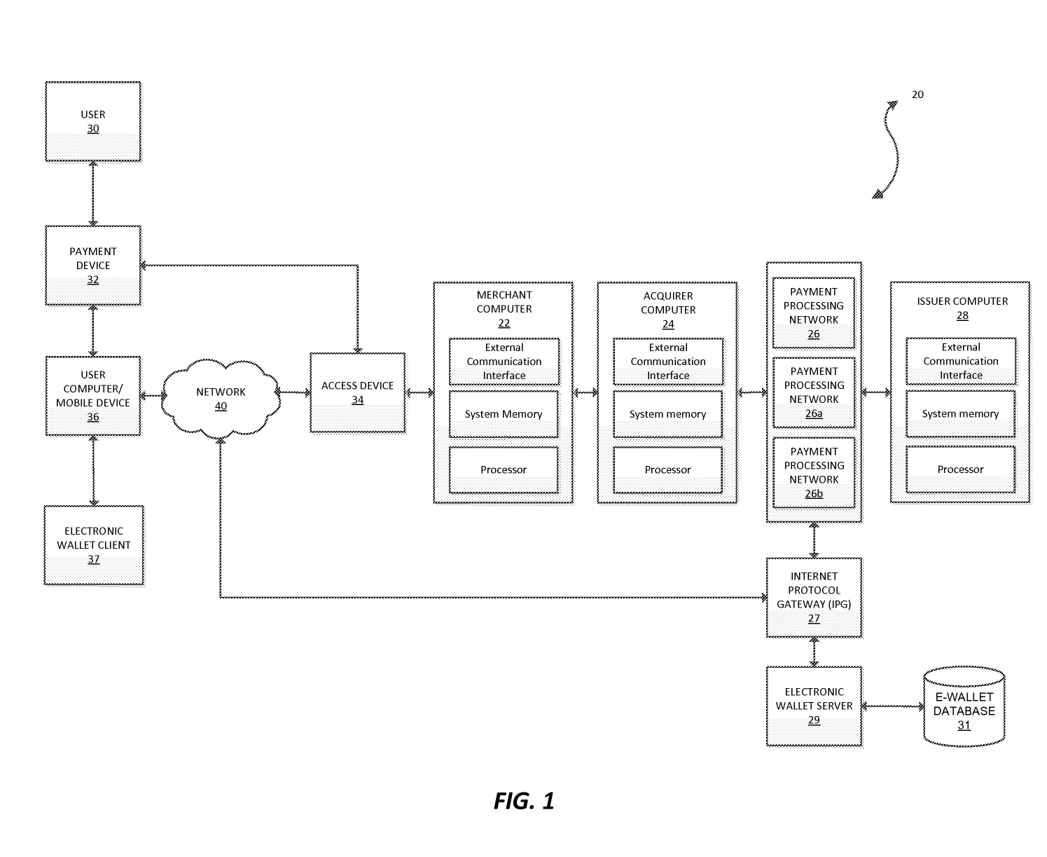

An exemplary financial transaction system is shown in FIG. 1. The system 20 may include one or more merchants, one or more access devices 34, one or more payment devices 32, one or more acquirers, and one or more issuers. For example, the system 20 may include a merchant having a merchant computer 22 that comprises an external communication interface (e.g. for communicating with an access device 34 and an acquirer 24), system memory comprising one or modules to generate and utilize electronic messages, and a data processor (for facilitating a financial transaction and the exchange of electronic messages); an acquirer having an acquirer computer 24 that comprises an external communication interface (e.g. for communicating with a merchant computer 22 and a payment processing network 26), system memory comprising one or modules to generate and utilize electronic messages, and a data processor (for facilitating a financial transaction and the exchange of electronic messages); and an issuer having an issuer computer 28 that comprises an external communication interface (e.g. for communicating with a payment processing network 26), system memory comprising one or modules to generate and utilize electronic messages, and a data processor (for facilitating a financial transaction and the exchange of electronic messages). The external communication interface of the merchant computer 22 may be coupled to an access device 34 (such that information may be received by the access device 34 and communicated to the merchant computer 22) or, in some embodiments, the access device 34 may comprise a component of the merchant computer 22.

As used in this context, an “external communication interface” may refer to any hardware and/or software that enables data to be transferred between two or components of system 20 (e.g., between devices residing at locations such as an issuer, acquirer, merchant, payment processing network 26, etc.). Some examples of external communication interfaces may include a modem, a network interface (such as an Ethernet card), a communications port, a Personal Computer Memory Card International Association (PCMCIA) slot and card, or the like. Data transferred via external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

As would be understood by one of ordinary skill in the art, any suitable communications protocol for storing, representing, and transmitting data between components in the system 20 may be used. Some examples of such methods may include utilizing predefined and static fields (such as in core TCP/IP protocols); “Field: Value” pairs (e.g. HTTP, FTP, SMTP, POP3, and SIP); an XML based format; and/or Tag-Length-Value format.

As shown in the exemplary system 20 in FIG. 1, information from the payment device 32 may be provided to access device 34 either directly (e.g. through a contact or contactless interface) or indirectly thorough a user computer or mobile device 36 (e.g. in an e-commerce environment or other indirect transaction) via network 40 (such as the Internet). In some embodiments, the user computer or mobile device 36 may interact with the payment processing network 26 (or other entity in the system 20) via the network 40 to form a first communications channel, such as through an Internet Protocol Gateway (IPG) 27. The IPG 27 may be in operative communication with the payment processing network 26. Although the IPG 27 is shown as being a separate entity in FIG. 1, the IPG 27 could be incorporated into the payment processing network 26, or could be omitted from the system 20. In the latter situation, the first communications channel could directly connect the payment processing network 26 and the user computer or mobile device 36. In general, providing communication from the user 30 to the payment processing network or other entity may enable a variety of increased functionalities to the user 30, such as advanced authentication and verification methods (particularly in e-commerce and similar transactions), examples of which are described in U.S. Ser. No. 12/712,148 filed on Jul. 16, 2010 and U.S. Ser. No. 13/184,080 filed on Jul. 15, 2011, each of which is incorporated by reference herein in its entirety. However, embodiments are not so limited.

In some embodiments, an electronic or digital wallet (i.e. “e-Wallet”) may be utilized as a payment device for conducting a financial transaction. As shown in FIG. 1, such exemplary systems may comprise an electronic wallet server 29, which may be accessible to the user 30 via network 40 (either directly connected or through an IPG 27) and may also be in operational communication a merchant and/or with a payment processing network 26 (or in some embodiments, the electronic wallet server 29 may comprise a part of the payment processing network 26). The electronic wallet server 29 may be programmed or configured to provide some or all of the functionality associated with conducting transactions using an electronic wallet, including maintaining an association between the user's e-wallet and one or more payment accounts (such as a bank account or credit card account) in E-Wallet database 31. To provide electronic wallet services (i.e. the use of the electronic wallet associated with a payment account to conduct a financial transaction), the electronic wallet server 29 may further provide a web interface (e.g. through one or more web pages) to receive and transmit requests for payments services and/or may provide an application program interface (API) (shown as electronic wallet client 37) at the user computer apparatus 36 to provide the web service. This process is described in more detail in U.S. Ser. No. 61/466,409 filed on Mar. 22, 2011, which is incorporated herein by reference in its entirety.

As noted above, the user's electronic wallet may be stored in the E-Wallet database 31, which may include information associated with the user's payment accounts can be used in conducting a financial transaction with a merchant. For example, the E-Wallet database 31 may include the primary account numbers of one or more payment accounts (e.g., payment accounts associated with a credit card, debit card, etc.) of the user 30. The e-wallet may be populated with such information during an initial enrollment process in which the user 30 enters information regarding one or more of the payment accounts that may be associated with various issuers. Once the payment account information is added to the E-Wallet database 31, the user 30 may perform transactions by utilizing only his e-wallet. When a user 30 performs a transaction using his electronic wallet, the user 30 need not provide the merchant with payment account information, but may instead provide the electronic wallet information. This information may then be included in an authorization request message, which in turn may be provided to payment processing network 26. The payment processing network 26 may then access the user's e-wallet via a request to the electronic wallet server 29, or may have direct access to the e-wallet database 31 so as to obtain the corresponding payment account information indicated by the information in the authorization request message.

The electronic wallet client 37 may comprises any suitable software that provides front end functionality of the electronic wallet to the user 30. For example, the electronic wallet client 37 may be embodied as a software application downloadable by a computer apparatus or mobile device 32 (e.g., a mobile phone). In some instances, the electronic wallet client 37 may provide a user interface (such as a series of menus or other elements) that allows the user 30 to manage his electronic wallet(s) (i.e. the electronic wallet client 37 may enable interaction with the electronic wallet server 29, and thereby the e-wallet database 31). In some embodiments, the electronic wallet client 37 may store data in a computer readable memory for later use, such as user 30 preferences or identifiers associated with funding sources added to the electronic wallet.

A payment processing network 26 may be disposed between the acquirer computer 24 and the issuer computer 28 in the system 20. In some embodiments, a plurality of different payment processing networks, such as payment processing networks 26, 26a, and 26b, may be disposed between the acquirer computer 24 and the issuer computer 28. For a given transaction, the payment processing network selected to route the given transaction may be selected according to embodiments of the present invention, as discussed further below. The components of an exemplary payment processing network 26 are described below with reference to FIG. 2 for illustration purposes. Furthermore, the merchant computer 22, the acquirer computer 24, the payment processing network 26, and the issuer computer 28 may all be in operative communication with each other (i.e. although not depicted in FIG. 1, one or more communication channels may exist between each of the entities, whether or not these channels are used in conducting a financial transaction).

The payment processing network 26 may include data processing subsystems, networks, and operations used to support and deliver authorization services, exception file services, and clearing and settlement services. For example, the payment processing network 26 may comprise a server computer, coupled to a network interface (e.g. by an external communication interface), and a database(s) of information. An exemplary payment processing network may include VisaNet™, CYBERSOURCE, AUTHORIZE.NET, PLAYSPAN, etc. . . . Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 26 may use any suitable wired or wireless network, including the Internet.

Although many of the data processing functions and features of some embodiments may be present in the payment processing network 26 (and a server computer therein), it should be understood that such functions and features could be present in other components such as the issuer computer 28, and need not be present in the payment processing network 26, or a server computer therein.

With reference to FIG. 2, an exemplary server computer 200 in payment processing network 26 is shown. The exemplary server computer 200 is illustrated as comprising a plurality of hardware and software modules (201-209). However, it should be appreciated that this is provided for illustration purposes only, and each of the modules and associated functionality may be provided and/or performed by the same or different components. That is, exemplary server computer 200 may, for example, perform some of the relevant functions and steps described herein with reference to the payment processing network 26 through the use of any suitable combination of software instructions and/or hardware configurations. It should be noted that although FIG. 2 illustrates all of the modules located on a single device, the disclosure is not meant to be so limited. Moreover, a system for implementing the functionality described herein may have additional components or less then all of these components. Additionally, some modules may be located on other devices such as a remote server or other local devices that are functionally connected to the server computer component(s).

The exemplary server 200 is shown as comprising a processor 201, system memory 202 (which may comprise any combination of volatile and/or non-volatile memory such as, for example, buffer memory, RAM, DRAM, ROM, flash, or any other suitable memory device), and an external communication interface 203. Moreover, one or more of the modules 204-209 may be disposed within one or more of the components of the system memory 202, or may be disposed externally. As was noted above, the software and hardware modules shown in FIG. 2 are provided for illustration purposes only, and the configurations are not intended to be limiting. The processor 201, system memory 202 and/or external communication interface 203 may be used in conjunction with any of the modules described below to provide a desired functionality. Some exemplary modules and related functionality may be as follows:

The communication module 204 may be configured or programmed to receive and generate electronic messages comprising information transmitted through the system 20 to or from any of the entities shown in FIG. 1. When an electronic message is received by the server computer 200 via external communication interface 203, it may be passed to the communications module 204. The communications module 204 may identify and parse the relevant data based on a particular messaging protocol used in the system 20. The received information may comprise, for instance, identification information, transaction information, and/or any other information that the payment processing network 26 may utilize in authorizing a financial transaction or performing a settlement and clearing procedure. The communication module 204 may then transmit any received information to an appropriate module within the server computer 200 (e.g. via a system bus line 250). The communication module 204 may also receive information from one or more of the modules in server computer 200 and generate an electronic message in an appropriate data format in conformance with a transmission protocol used in the system 20 so that the message may be sent to one or more components within the system 20 (e.g. to an issuer computer 28 or merchant computer 22). The electronic message may then be passed to the external communication interface 203 for transmission. The electronic message may, for example, comprise an authorization response message (e.g. to be transmitted to a merchant conducting a transaction) or may be an authorization request message to be transmitted or forwarded to an issuer.

The database look-up module 205 may be programmed or configured to perform some or all of the functionality associated with retrieving information from one or more databases 210. In this regard, the database look-up module 205 may receive requests from one or more of the modules of server 200 (such as communication module 204, authorization module 208, or settlement module 209) for information that may be stored in one or more of the databases 210. The database look-up module 205 may then determine and query an appropriate database. The database update module 206 may be programmed or configured to maintain and update the databases 210, such as authorization database 215. In this regard, the database update module 206 may receive information about a user, financial institution, a payment device, and/or current or past transaction information from one of the modules discussed herein. This information may then be stored in an appropriate location in the databases 210 using any suitable storage process.

The report generation module 207 may be programmed or configured to perform some or all of the functionality associated with generating a report regarding a user, an account, a transaction or transactions, or any other entity or category of information with regard to system 20. This may include, for instance, identifying patterns (such as patterns that indicate a fraudulent transaction or transactions) and generating one or more alerts that may be sent (e.g. via communication module 204 and external communication interface 203) to one or more entities in the system 20, including the user, merchant, or issuer. The report generation module may also, for example, request information from one or more of the databases 210 via database look-up module 205.

The authorization module 208 may be configured or programmed to perform some or all the functionality associated with authorizing a financial transaction associated with an authorization request message. The authorization request message may be generated by a merchant computer 22 and may be associated with a transaction involving the payment device 32. The authorization request message may include any suitable information that may be used to authorize or identify the transaction, and may be generated by the merchant computer 22 in response to an interaction between a payment device 32 or a mobile device 36 and an access device 34). The authorization module 208 may, for instance, be programmed or configured to compare the information received by via the authorization request message with stored information at the server 200 or a database 210 (such as comprising verification values). In some embodiments, if the received and stored values match, the authorization module 208 may authorize the transaction (or may be more likely to authorize the transaction) and may instruct the communication module 201 to generate an authorization response message. The authorization module 207 may also be programmed or configured to execute any further operations associated with a typical authorization.

The payment processing network 26 may include one or more databases 210, such as authorization database 215. Each of the databases shown in this example may comprise more than one database, and may be located in the same location or at different locations. The authorization database 215 may contain information related to a payment device 32 and/or a payment account, as well as any other suitable information (such as transaction information) associated with the payment account. For example, the authorization database 215 may comprise a relational database having a plurality of associated fields, including a primary account identifier (e.g. a PAN), an issuer associated with the account, expiration date of a payment device 32, a verification value(s), an amount authorized for a transaction, a user name, user contact information, prior transaction data, etc. In some embodiments, the authorization module 208 may utilize some or all of the information stored in the authorization database 215 when authorizing a transaction.

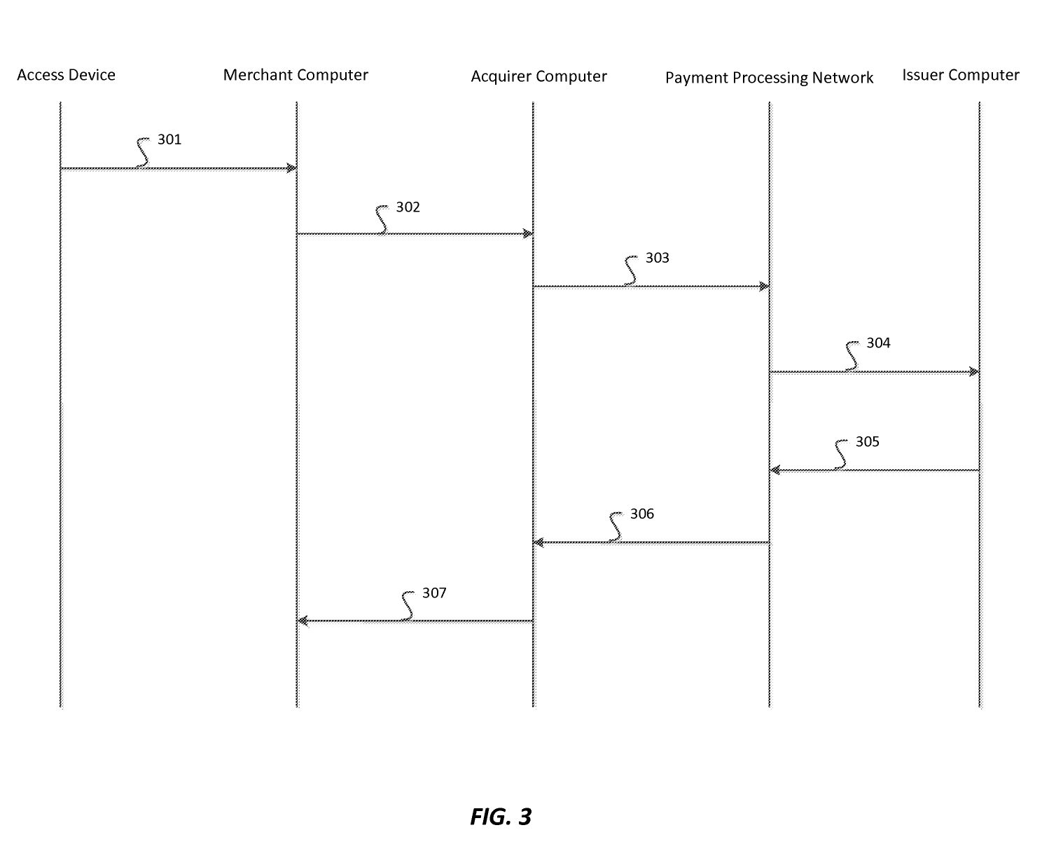

Methods for example financial transaction systems 20 are described below with reference to FIG. 3, and with further reference to the system elements in FIGS. 1 and 2. The methods described below are exemplary in nature, and are not intended to be limiting. Methods in accordance with some embodiments described herein may include (or omit) some or all of the steps described below, and may include steps in a different order than described herein.

A typical credit card transaction flow using a payment device 32 at an access device 34 (e.g. POS location) can be described as follows. A user 30 presents his or her payment device 32 to an access device 34 to pay for an item or service. The payment device 32 and the access device 34 interact such that information from the payment device 32 (e.g. PAN, verification value(s), expiration date, etc.) is received by the access device 34 (e.g. via contact or contactless interface). As shown in FIG. 3, the merchant computer 22 may then receive this information at step 301 from the access device 34 via the external communication interface. The merchant computer 22 may then generate an authorization request message that includes the information received from the access device 34 (i.e. information corresponding to the payment device 32) along with additional transaction information (e.g. a transaction amount, merchant specific information, etc.) and at step 302 electronically transmit this information to an acquirer computer 24. The acquirer typically represents, and vouches for, the merchant in financial transactions (e.g. credit card transactions). The acquirer computer 24 may then receive (via its external communication interface), process, and at step 303 forward the authorization request message to a payment processing network 26 (such as the server computer 200 shown in FIG. 2), for authorization.

In general, prior to the occurrence of a credit-card transaction, the payment processing network 26 has an established protocol with each issuer on how the issuer's transactions are to be authorized. In some cases, such as when the transaction amount is below a threshold value, the authorization module 208 of the payment processing network 26 may be configured to authorize the transaction based on information that it has about the user's account without generating and transmitting an authorization request message to the issuer computer 28. In other cases, such as when the transaction amount is above a threshold value, the payment processing network 26 may receive the authorization request message via its external communication interface 203, determine the issuer associated with the payment device 32, and then at step 304 forward the authorization request message for the transaction to the issuer computer 28 for verification and authorization. As part of the authorization process, the payment processing network 26 or the issuer computer 28 may analyze a verification value or other datum provided by the payment device 32. The verification value may be stored at the issuer or the payment processing network 26 (e.g. in one of the databases 210). Once the transaction is authorized, at step 305 the issuer computer 28 may generate an authorization response message (that may include an authorization code indicating the transaction is approved or declined) and transmit this electronic message via its external communication interface to payment processing network 26. At step 306, the payment processing network 26 may then forward the authorization response message via a communication channel to the acquirer computer 24, which in turn at step 307 may then transmit the electronic message to comprising the authorization indication to the merchant computer 22.

When a user 30 wishes to make an online purchase with a merchant over the Internet (i.e. e-commerce), a similar method as described above with reference to FIG. 3 may be performed except that the user 30 may use his computer apparatus or mobile device 36 to provide information associated with a payment device 32 (e.g. account number, user's name, expiration date, verification value, etc.) into respective fields on the merchant's checkout page (e.g. functioning as an access device 34). The access device 34 may then provide this information to the merchant computer 22, and steps 301-307 may be performed.

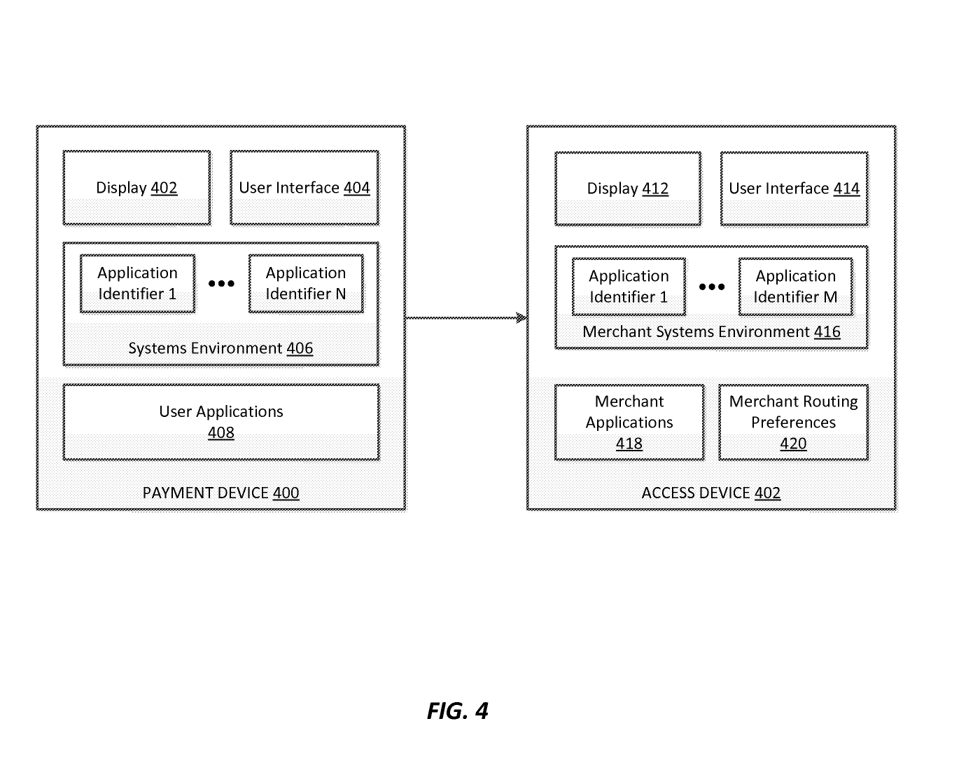

FIG. 4 shows a system for conducting payment transactions with multiple routing options in accordance with some embodiments. As shown in FIG. 4, a payment device 400, one example of such a payment device is payment device 32 shown in FIG. 1, can include a display 402 and user interface 404. In some embodiments, payment device 400 can be a contactless payment device such as a mobile device or payment card. In some embodiments, such as where the payment device is a payment card, the display 402 and user interface 404 may not be included in the payment device. Payment device 400 can further include a systems environment 406 which includes a plurality of application identifiers (AIDs) that each correspond to a different payment method and/or routing option supported by payment device 400. Payment device 400 can further store user applications 408 that are associated with the consumer's payment device. The systems environment 406 can be configured by an issuer associated with the payment device 400. Additional elements of example payment devices are further discussed below with respect to FIGS. 10 and 11.

In accordance with an embodiment, payment device 400 can include a plurality of different applications 408. As used herein, an application refers to any computer program and associated data that resides on the payment device and satisfies a business function. Each application can enable the payment device 400 to support a different payment method and/or routing option. For example, a payment device may include a credit payment application and a plurality of debit payment applications. Other examples of types of applications can include stored value, rebate, and loyalty accounts. Where the payment device is a payment card the applications can be stored on an integrated circuit chip embedded in the card; where the payment device is a mobile device or computing device the applications can be stored on a computer readable memory which is accessible to the mobile or computing device either locally (i.e., integrated in the device) or remotely via a cloud or similar service.

A list of applications supported by the payment device 400 can be stored in a systems environment 406. For a contact payment device, such as a payment card, the systems environment can be a Payment Systems Environment (PSE); for contactless payment devices, the list of supported applications can be stored in a Proximity Payment Systems Environment (PPSE). The list of supported applications can include, for each listed application, an Application Identifier (AID), an application label and an application priority indicator. The list of supported (i.e., available) applications may also be referred to as the PSE, or PPSE, Directory Entry list.

Payment device 400 can interact with access device 402 to complete a transaction. Access device 402 can be, e.g., a point of sale terminal, an ATM or any other suitable device that can communicate with a consumer's payment device and a payment processing network to complete transactions. One example of an access device is access device 34, as shown in FIG. 1. As shown in FIG. 4, access device 402 can include a display 412 and user interface 414 that enable the consumer to interact with the access device. Access device 402 can also include a plurality of applications 418 corresponding to the payment processing networks that are supported by a particular merchant. For example, these routing options may include a plurality of payment processing networks for credit and debit transactions that the merchant supports. Merchant systems environment 416 can include a plurality of application identifiers corresponding to the applications on access device 402. The list of supported applications can include, for each listed application, an Application Identifier (AID), an application label and an application priority indicator. Additionally, or alternatively, the access device can include merchant routing preferences 420 that can be configured by a merchant to indicate a routing priority for the supported applications 418.

When a payment device is presented to an access device to perform a transaction, the transaction can be completed using one of the applications which is shared by both devices. For example, in a debit transaction, when the payment device is presented to the access device, the transaction can be routed to any payment processing network which is supported by both devices.

In some embodiments, the consumer and the merchant can each independently prioritize the applications supported by their devices. As described above, the consumer's payment device can include several different credit/debit payment applications, each of which route transactions over a different payment processing network. The consumer can choose to prioritize the applications based on a rewards program or other network-specific incentives offered by a particular payment processing network. Similarly, the merchant can prioritize based on which payment processing network charges the lowest fees.

In accordance with an embodiment, the consumer can set their payment processing network preferences when they are issued the payment device or the issuer can set default preferences for the consumer. Alternatively, the consumer can set their preferences by interfacing with the payment device via a personal computer, standalone kiosk, ATM or similar device. Additionally, or alternatively, the consumer can set their preferences online through their customer account associated with the payment device and have their preferences updated on the payment device the next time it is used for a transaction at an access device. In embodiments where the payment device is a mobile device or computing device that includes a display and user interface, the payment device can include a processor that enables the consumer to directly modify and/or update their preferences by interacting with the payment device through the display and user interface. For example, the consumer can set their preferences by ranking each AID. In some embodiments, the consumer may be able to customize the application label associated with each AID. Further, in some embodiments, the consumer may be able to associate custom information with each AID. For example, the consumer can enter rewards, benefits, or other information that is associated with an AID and that can be displayed to the consumer during a transaction.

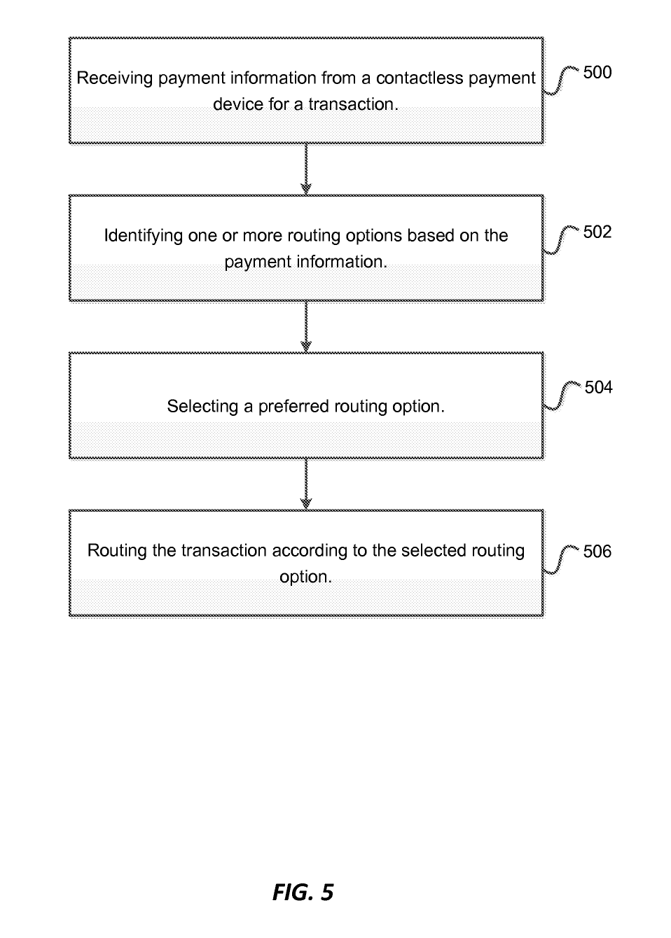

In accordance with an embodiment, for contactless payment devices, including contactless cards, mobile phones, etc., the systems environment can be utilized by an access device to get the list of available applications on the payment device. Using the list of available applications and the consumer's and merchant's priority information, a transaction can be routed in a number of alternative ways, as further described below with respect to FIGS. 5-8. In accordance with an embodiment, the following data elements can be read from the payment device:

TABLE 1
Example data elements read from a
payment device by an access device.

| Data Element Name | Tag | Comment |
|---|---|---|
| ADF Name | ‘4F’ | Also referred to as AID |
| Application Priority | ‘87’ | In accordance with an embodiment, the |
| Indicator | | lower a value, the higher a priority (except |
| | | for zero, which can indicate “No priority”) |
| Directory Entry | ‘61’ | There is one directory entry per AID in |
| | | the systems environment each defining |
| | | a separate ADF Name, Application Prior- |
| | | ity Indicator and (optionally) Issuer |
| | | Identification Number |
| Issuer Country Code | ‘5F55’ | Country code for US is “US” |
| Issuer Identification | ‘42’ | Also referred to as the Bank Identification |
| Number (IIN) | | Number (BIN) |

FIG. 5 shows a method of performing a payment transaction with multiple routing options in accordance with some embodiments. At step 500, an access device, such as access device 402, can receive payment information from a payment device, such as payment device 400, for a transaction. In accordance with an embodiment, the payment device can be a contactless payment device. As described above, the payment information can include a list of application identifiers supported by the payment device and priority information associated with the application identifiers. In some embodiments, the payment information can further include a selection of one or more preferred routing options indicated by the consumer. At step 502, the access device can identify one or more routing options based on the payment information. The one or more routing options can be determined by the access device by comparing the list of application identifiers received from the payment device, to a list of application identifiers (and corresponding routing options) stored on the access device. In some embodiments, the plurality of routing options (represented by the application label of the AID corresponding to each routing option) can be presented on a display connected to the access device. Alternatively, or additionally, the access device can send a message to the payment device that requests the payment device display the plurality of routing options to the consumer. In some embodiments, the plurality of routing options presented to the consumer can be sorted according to the merchant's routing preferences, or according to the consumer's routing preferences.

At step 504, the access device can select an AID corresponding to a preferred routing option. The selection can be based on programmed preferences, such as merchant routing preferences 420, stored on or accessible to the access device 402. In some embodiments, the selection can also be based on routing preferences and/or input received from the consumer. For example, the plurality of routing options can be presented to the consumer on a display connected to the payment device, the consumer can make a selection using a user interface connected to the payment device, and the payment device can send a message to the access device indicating the consumer's selection. Based on the merchant routing preferences and, in some embodiments, the consumer preferences, the preferred routing option can be selected. At step 506, the access device can route the transaction according to the selected routing option.

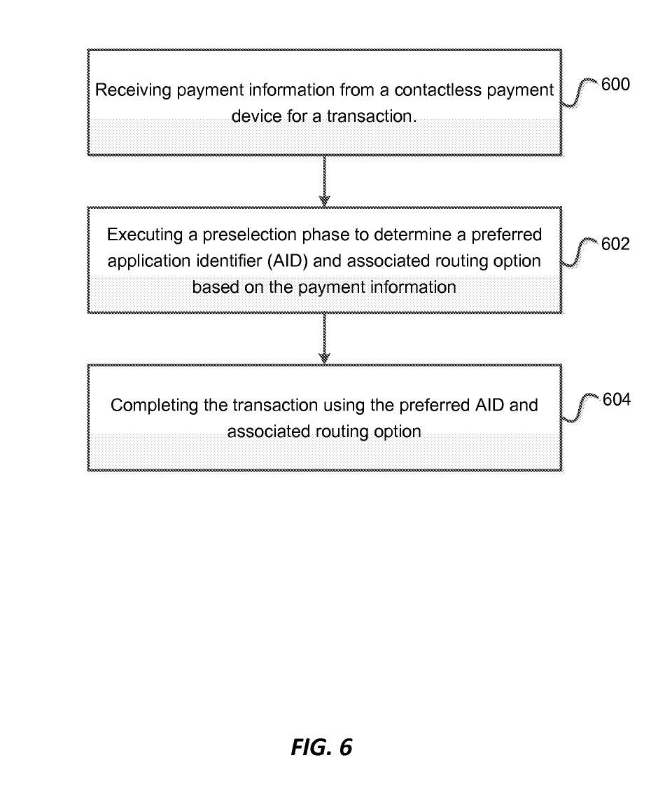

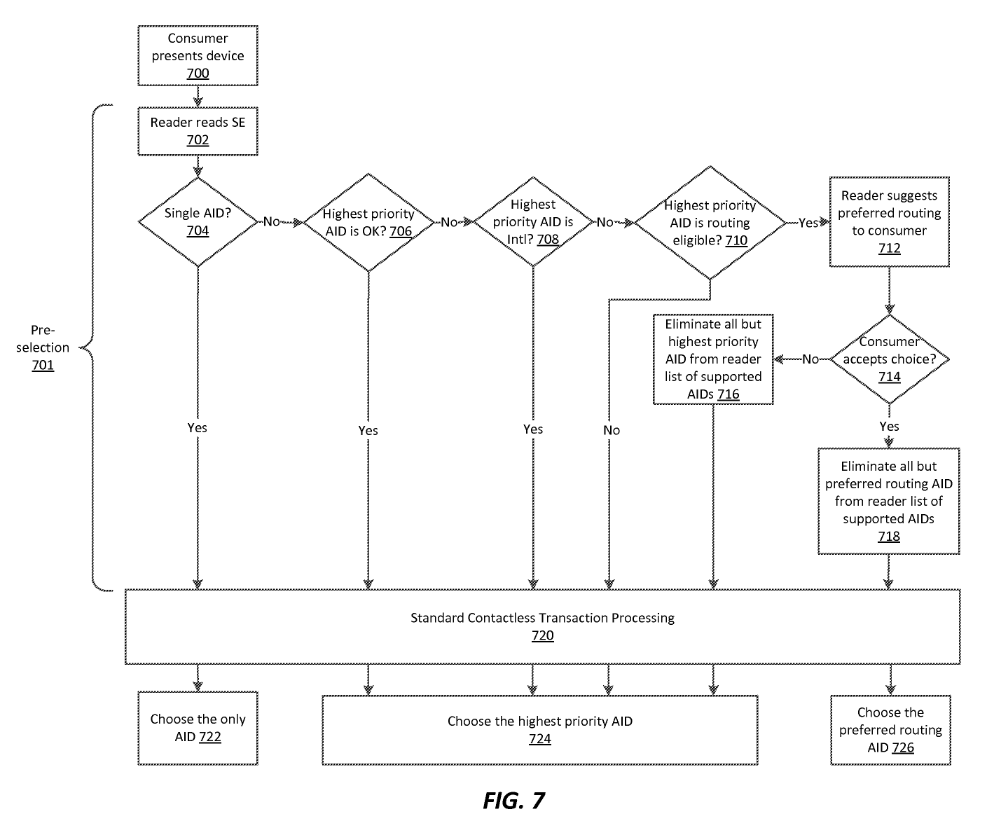

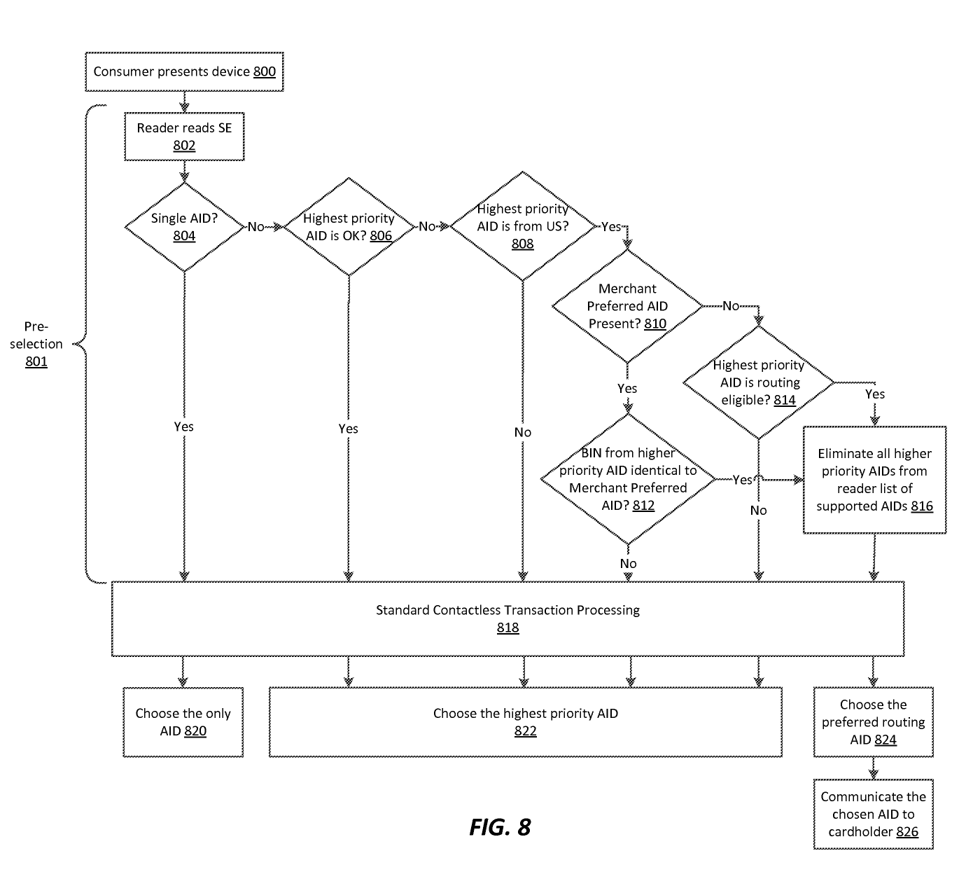

FIG. 6 shows a method of performing a payment transaction that invokes pre-selection processing in accordance with some embodiments. The method described above with respect to FIG. 5 enables the consumer and merchant to quickly determine a shared routing option and complete a transaction using the shared routing option. In more complicated transactions, where many routing options are shared and/or there are conflicting routing preferences between the consumer and the merchant, a preselection process can be invoked to quickly determine an acceptable routing option to the consumer and the merchant. At step 600, payment information is received by an access device from a payment device. At step 602, a preselection phase can be executed to determine a mutually acceptable application identifier and corresponding routing option based on the payment information. The preselection phase, as described further below with respect to FIGS. 7 and 8, can determine how many application identifiers are included in the payment information, compare the consumer's preferences to the merchant's preferences, determine any applicable regulatory or contractual obligations for a given routing option and then determine a routing option that is acceptable to the merchant and to the consumer. Once the routing option is identified, the consumer can re-present their payment device to the access device. At step 604, the transaction is processed using the routing option.

FIG. 7 shows a method of performing pre-selection processing in accordance with some embodiments. As shown in FIG. 7, at 700 a consumer can present a payment device, such as payment device 400, to an access device, such as access device 402, to perform a transaction. The payment device can be a payment card, contactless payment card, a mobile device, or other suitable payment device. In order to support additional routing options, an access device can be configured to execute a “pre-selection” phase 701 before the standard transaction flow. During the pre-selection phase, at 702 the access device can read the systems environment (such as systems environment 406) and determine a list of available AIDs on the payment device. The access device can then execute the remainder of the pre-selection phase using the list of AIDs on the payment device and the list of supported AIDs on the access device. The list of supported AIDs on the access device can be stored in a merchant systems environment, such as merchant systems environment 416, as shown in FIG. 4.

At 704, the access device can determine if the systems environment includes a single AID which is also supported by the access device. If so, the pre-selection phase ends and processing continues with a standard contactless payment transaction flow 720 without involving the consumer, and the only available AID is selected at 722 for use in the transaction.

If the systems environment includes more than a single mutually supported AID, then processing proceeds to 706. At 706, the access device determines whether the consumer's highest priority AID is acceptable to the merchant. This can be determined by, for example, comparing the consumer's highest priority AID against a prioritized list of AIDs for the merchant, and/or by executing a plurality of business to rules to dynamically identify the merchant's preferred AID and comparing the merchant's preferred AID to the consumer's highest priority AID. The prioritized list of AIDs for the merchant can indicate one or more AIDs that are preferred, and assigned a higher priority, and one or more AIDs that are not preferred and are assigned a lower priority. A preferred AID may be any AID the merchant has marked as preferred, or any AID having a priority over a predetermined value. For example, if the merchant's systems environment includes five ranked AIDs, any AID ranked third or better may be considered preferred. Alternative ranking schemes and preferred values are also possible. If the merchant's preferred AID is determined dynamically by executing the plurality of business rules, for example to determine a lowest cost routing option for a particular transaction, then the output AID from the plurality of business rules is the preferred AID. If the consumer's preferred AID is acceptable, then processing continues with the standard contactless transaction flow 720 without involving the consumer, and the highest priority AID is selected at 724 for use in the transaction. If the consumer's highest priority AID is not acceptable to the merchant, then processing continues to 708.

At 708, the access device can determine a country code associated with the highest priority AID and apply country-specific routing rules, if needed, that determine how the transaction is routed. For example, as shown in FIG. 7, the access device can determine an Issuer Country Code of the consumer's highest priority AID. In the example shown in FIG. 7, different routing rules apply to U.S. issuers and to international issuers. However, this step can be customized for other countries and/or regions. If no Issuer Country Code can be determined, or if the included Issuer Country Code is not identical to “US”, then processing continues with a standard contactless transaction flow 720 without involving the consumer, and the highest priority AID is selected at 724 for use in the transaction. If the consumer's highest priority AID is not an international AID, then processing proceeds to 710.

At 710, the access device determines whether the highest priority AID is eligible for alternative routing. One way of determining this is based on IIN or BIN associated with the AID. If the access device has access to BIN tables, for example either stored locally or accessible through a cloud computing environment, then the BIN corresponding to the highest priority AID can be compared to the BIN table to determine whether that AID is eligible for alternative routing options. If no BIN is available, or if the BIN is not eligible for alternative routing options, then processing continues with the standard contactless transaction flow 720 without involving the consumer, and the highest priority AID is selected at 724 for use in the transaction.

If the BIN is eligible for alternative routing options, then the access device can query the other available AIDs in the list of available applications to determine whether a merchant-preferred application is available. If one of the AIDs representing a preferred merchant routing option is present, the transaction can be temporarily suspended and processing proceeds to 712. If none of the AIDs representing a preferred merchant routing option are present, processing continues with the standard contactless transaction flow 720 without involving the consumer, and the highest priority AID is selected at 724 for use in the transaction.

Additionally, if the access device does not have access to BIN tables, another way of determining at 710 whether the highest priority AID is eligible for alternative routing is where the consumer can indicate a product type using the access device (e.g., where the access device includes a debit/credit button which the user can select). If the consumer indicates a product that is not eligible for alternative routing, processing can continue with the standard contactless transaction flow 720 without further involving the consumer. If, instead, the consumer indicates a product that is eligible for routing, then the systems environment on the payment device can be queried to determine whether it includes an AID representing a preferred routing option of the merchant. If the systems environment includes an AID associated with the preferred routing option, then the transaction can be temporarily suspended and processing continues to 712. If, however, the systems environment does not include an AID representing the merchant's preferred routing option, then processing continues with the standard contactless transaction flow 720 without further involving the consumer, and the highest priority AID is selected at 724 for use in the transaction. Additionally, the payment device can include a form factor indicator which identifies the payment device to the access device as a card, mobile phone, or other type of payment device.

At 712, alternative routing options can be presented to the consumer. These options can be displayed on a screen integrated into the payment device, displayed on a screen on the access device or presented via conversation with the merchant. When the alternative options are displayed to the consumer on the payment device or on the access device, each displayed option can include an Application Label associated with the option (for example a logo or other identifying mark associated with that option). Additionally a description of potential benefits or incentives associated with each option can be displayed to the consumer. For example, if selection of a particular option would accrue rewards points to the consumer, a description of the rewards program and the number of points the consumer would earn can be displayed.

At 714, the consumer selects a routing option. This selection can be performed via the payment device (such as payment device 400) or access device (such as access device 402) directly in response to the displayed options discussed above with respect to 712, or via conversation with the merchant. If the consumer does not select the merchant's preferred routing option, processing proceeds to 716. At 716, the list of supported applications in the access device is altered, for this transaction, to include only the consumer's preferred AID. The consumer can then re-present the payment device. With only one shared AID, processing will be similar to that described above with respect to 704. Processing proceeds to the standard contactless transaction flow 720, and at 724 the only mutually supported AID, the consumer's preferred option, is selected for use in the transaction.

Alternatively, if the consumer selects the merchant's preferred routing option, then processing proceeds to 718. At 718, similarly to 716, the list of supported applications in the access device is altered, for this transaction, to include only the merchant's preferred AID. As in 716, at 718 when the consumer re-presents the payment device only one mutually supported AID is found. Processing proceeds to the standard contactless transaction flow 720, and at 726 the only mutually supported AID, the merchant's preferred option, is selected for use in the transaction.

FIG. 8 shows an alternative method of performing pre-selection processing in accordance with some embodiments. In the pre-selection phase shown in FIG. 7, the consumer re-presents their payment device, once a mutually agreed upon routing option has been selected. This slows the transaction process by requiring a second presentation of the payment device. The pre-selection phase shown in FIG. 8, does not require a second presentation of the payment device and instead enables merchants to complete the transaction using the merchant's preferred AID without further input from the consumer.

As shown in FIG. 8, processing begins at 800 when the user presents their payment device, such as payment device 400, to an access device, such as access device 402, to complete a transaction. At 802, an access device, such as access device 402, can read the systems environment (e.g., systems environment 406) of the payment device to obtain the list of AIDs supported by the payment device. A pre-selection phase 801 can then be executed to select a preferred AID and corresponding routing option for the transaction. At 804, if the systems environment includes a single mutually supported AID, then processing can proceed to 818 and a standard contactless payment transaction flow can be executed, and the only available AID is selected at 820 for use in the transaction.

At 806, if the systems environment includes a plurality of mutually supported AIDs, the access device can determine whether the consumer's highest priority AID represents a routing option that is acceptable to the merchant. If the consumer's highest priority AID is acceptable, then processing can proceed to 818 and a standard contactless payment transaction flow can be executed, and the highest priority AID is selected at 822 for use in the transaction.

If the consumer's highest priority AID represents a routing option that is not acceptable to the merchant, processing can proceed to 808. At 808, the access device can determine a country code associated with the highest priority AID and apply country-specific routing rules, if needed, that determine how the transaction is routed. For example, as shown in FIG. 8, the access device can determine an Issuer Country Code of the consumer's highest priority AID. In the example shown in FIG. 8, different routing rules may apply to U.S. issuers and to international issuers. However, this step can be customized for other countries and/or regions. At 808 the access device can determine whether the highest priority AID corresponds to a United States Issuer. If the AID does not include an Issuer Country Code or if the included issuer Country Code is not identical to “US”, then processing can proceed to 818 and a standard contactless payment transaction flow can be executed, and the highest priority AID is selected at 822 for use in the transaction.

At 810, if the highest priority AID is from the United States, the access device can determine whether the systems environment includes a merchant preferred AID. In accordance with an embodiment, the merchant preferred AID can be set by the merchant and stored in the merchant AID preferences 418. For example, the merchant preferred AID can be set to be the US Common Debit AID. In some embodiments, the merchant preferred AID can be set by an acquirer. If the systems environment includes the merchant preferred AID, at 812 the access device can compare a BIN of the merchant preferred AID with BINs, if present, of any other AIDs in the systems environment that have higher priority than the merchant preferred AID. If the BINs are not present for the higher priority AIDs, or if the BINs are not equal to the BIN present for the merchant preferred AID, then processing can proceed to 818 and a standard contactless payment transaction flow can be executed, and the highest priority AID is selected at 822 for use in the transaction.

If the BIN for the merchant preferred AID matches the BIN of the higher priority AIDs then processing can proceed to 816. At 816, the access device can select the AID reflecting the preferred merchant choice and eliminate any higher priority AIDs from the access device's list of supported AIDs. Processing can then proceed to 818 and a standard contactless payment transaction flow can be executed. At 824, the highest priority AID, which is now the merchant's preferred AID is selected for use in the transaction. At 826, the consumer can be notified of the selected AID. For example, the access device can display the selected AID and/or the routing information can be included on a receipt that is provided to the consumer.

In some embodiments, at 812, the consumer can provide a routing selection in which the consumer selects a preferred routing option. For example, the consumer may select a credit/debit button on the access device. If the consumer's selection is not eligible for alternative routing, then processing can proceed to 818 and a standard contactless payment transaction flow can be executed, and the highest priority AID is selected at 822 for use in the transaction. In this case, the highest priority AID can correspond to the consumer's selected routing option.

If the consumer's payment device does not include the merchant preferred AID, then processing can proceed to 814. At 814, the access device can determine whether the highest priority AID is eligible for alternative routing by the merchant. In some embodiments, the access device can use BIN tables to determine whether the AID is eligible for alternative routing. If the highest priority AID does not include a BIN or the included BIN is not eligible for alternative routing, then processing can proceed to 818 and a standard contactless payment transaction flow can be executed, and the highest priority AID is selected at 822 for use in the transaction. If the highest priority AID includes a BIN that is eligible for alternative routing by the merchant, then processing can proceed to 816.

At 816, it has been determined that the AID corresponding to the consumer's preferred routing option is eligible for alternative routing by the merchant. That is, if an AID is supported by the consumer, that is preferred by the merchant, the merchant can override the consumer's preferences and route the transaction using the merchant's preferred option. If none of the AIDs representing a preferred merchant routing option are present, then processing can proceed to 818 and a standard contactless payment transaction flow can be executed, and the highest priority AID is selected at 822 for use in the transaction. If an AID representing a preferred merchant routing option is present, the access device can eliminate any higher priority AIDs in the access device's list of supported AIDs for the transaction. Processing can then proceed to 818 and a standard contactless payment transaction flow can be executed. At 824, the highest priority AID, which is now the merchant's preferred AID is selected for use in the transaction. At 826, the consumer can be notified of the selected AID. For example, the access device can display the selected AID, the user's payment device can display the selected AID, and/or the routing information can be included on a receipt that is provided to the consumer.

In some embodiments, an access device that does not have access to BIN tables can determine whether a transaction is eligible for alternative routing by the merchant based on input received from the consumer. For example, the consumer can indicate a debit or credit transaction by making a selection using the access device. If the consumer selects an option that is not eligible for routing, then processing can proceed to 818 and a standard contactless payment transaction flow can be executed, and the highest priority AID is selected at 822 for use in the transaction. Similarly, if the cardholder has indicated a product that is eligible for routing, but the consumer's list of supported AIDs does not include an AID representing the merchant's preferred routing option, then processing can proceed to 818 and a standard contactless payment transaction flow can be executed, and the highest priority AID is selected at 822 for use in the transaction. If the consumer selects a product that is eligible for routing, and the consumer's list of supported AIDs includes an AID that represents the merchant's preferred routing option, then processing can proceed to 818 and a standard contactless payment transaction flow can be executed. At 824, the highest priority AID, which is now the merchant's preferred AID is selected for use in the transaction. At 826, the consumer can be notified of the selected AID. For example, the access device can display the selected AID, the user's payment device can display the selected AID, and/or the routing information can be included on a receipt that is provided to the consumer.

As described above, the pre-selection phase shown in FIG. 8 does not require additional input from the consumer before use in the transaction according to the merchant's preferred routing option. This can lead to unexpected results for the consumer. For example, the consumer may be expecting to enter a PIN for a transaction, but is instead asked to sign for the transaction. To avoid surprising the consumer, the preferred routing option can be displayed on the access device or on a display visible to the consumer. Additionally, by including the routing information on the receipt, the consumer can be kept informed of how a transaction has been routed.

Provided below are descriptions of some devices (and components of those devices) that may be used in the systems and methods described above. These devices may be used, for instance, to receive, transmit, process, and/or store data related to any of the functionality described above. As would be appreciated by one of ordinary skill in the art, the devices described below may have only some of the components described below, or may have additional components.

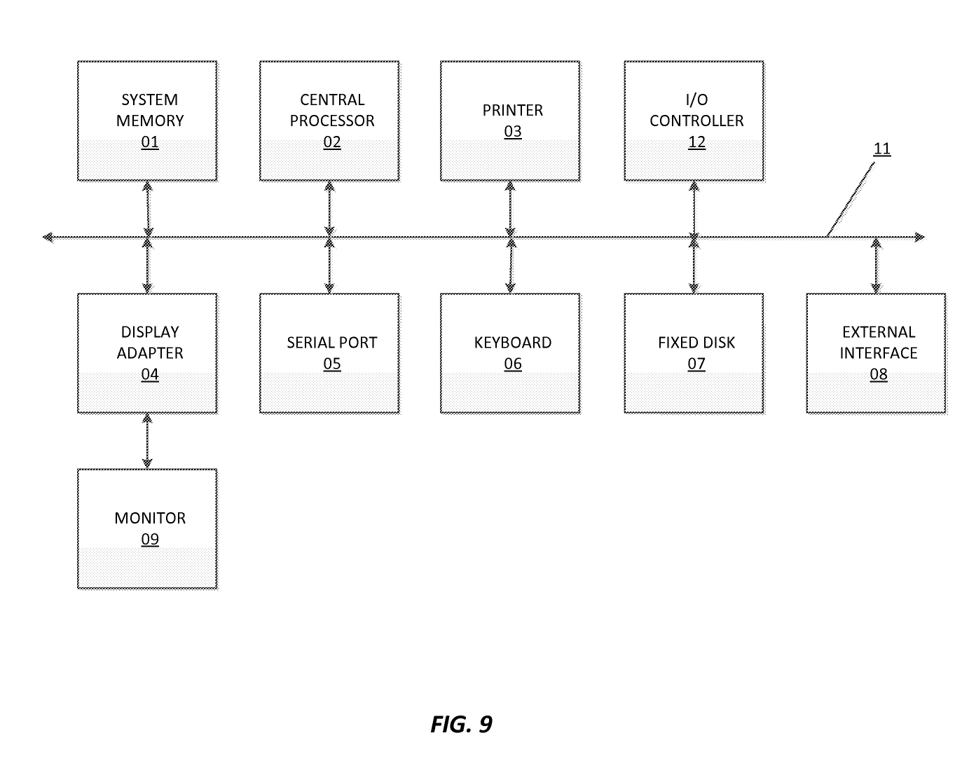

FIG. 9 illustrates exemplary elements of a computer apparatus. As noted above, the various participants and elements shown in FIGS. 1 and 2 can operate one or more computer apparatuses to facilitate the functions described herein. As would be appreciated by one of skill in the art after reading this disclosure, any of the elements in FIGS. 1 and 2 can use any suitable number of systems and subsystems to facilitate the functions described herein. Moreover, each of the systems and subsystems may comprise any number of hardware and software modules, such as those described above.

Examples of such systems, subsystems, and components are shown in FIG. 9. The subsystems and components shown in FIG. 9 are interconnected via a system bus 11. Additional subsystems such as a printer 03, keyboard 06, fixed disk 07 (or other memory comprising computer readable media), monitor 09, which is coupled to display adapter 04, and others are shown. Peripherals and input/output (I/O) devices, which coupled to I/O controller 12, can be connected to the computer system by any number of means known in the art, such as serial port 05. For example, serial port 05 or external interface 08 can be used to connect the computer apparatus to a wide area network such as the Internet, a mouse input device, or a scanner. The interconnection via system bus allows the central processor 02 to communicate with each subsystem and to control the execution of instructions from system memory 01 or the fixed disk 07, as well as the exchange of information between subsystems. The system memory 01 and/or the fixed disk 07 can embody a computer readable medium.

With reference to FIG. 10, a block diagram of an exemplary mobile device 36 is shown that may be used in some embodiments. In some embodiments, the mobile device 36 may be a notification device that can receive alert messages, a payment device that can be used to make payments, an access device (e.g. POS device) that may receive information from a consumer to conduct a transaction, and/or a multi-purpose general use device. The exemplary mobile device 36 shown in FIG. 10 may comprise a computer readable medium 36(b) that be present within the body (or outer casing) 36(h), or the computer readable medium 36(b) could be detachable from the device (e.g. the computer readable medium 36(b) could comprise an external memory that could be connected through a physical interface such as a USB connection, or the data could be hosted remotely and accessed wirelessly by the device—e.g. the data could be hosted and stored at a remoter server in the “cloud”). The computer readable medium 36(b) may be in the form of a memory that stores data. The memory may store information such as financial information, transit information (e.g., as in a subway or train pass), access information (e.g., access badges), serial numbers, mobile account information, and any other suitable information, e.g., the systems environment and list of AIDs as described above. In general, any of this information may be transmitted by the mobile device 36 (such as to an access device 34), via any suitable method, including the use of antenna 36(a) or contactless element 36(g). The body 36(h) may be in the form a plastic substrate, housing, or other structure.

In some embodiments, the mobile device 36 may further include a contactless element 36(g), which is typically implemented in the form of a semiconductor chip (or other data storage element) with an associated wireless transfer (e.g., data transmission) element, such as an antenna. Contactless element 36(g) may be coupled to (e.g., embedded within) the mobile device 36 and data or control instructions that are transmitted via a cellular network may be applied to the contactless element 36(g) by means of a contactless element interface (not shown). The contactless element interface functions to permit the exchange of data and/or control instructions between the mobile device circuitry and an optional contactless element 36(g), or between another device having a contactless element (e.g. a POS terminal or a payment device). Contactless element 36(g) may be capable of transferring and receiving data using a short range wireless communication capability. As noted above, mobile device 36 may comprise components to both be the interrogator device (e.g. receiving data) and the interrogated device (e.g. sending data). Thus, the mobile device 36 may be capable of communicating and transferring data or control instructions via both cellular network (or any other suitable wireless network—e.g. the Internet or other data network) and short range communications.

The mobile device 36 may also include a processor 36(c) (e.g., a microprocessor) for processing the functions of the phone 36 and a display 36(d) to allow a consumer to see phone numbers and other information and messages. The mobile device 36 may further include input elements 36(e) to allow a user to input information into the device, a speaker 36(f) to allow the user to hear voice communication, music, etc., and a microphone 36(i) to allow the user to transmit her voice through the mobile device 36. The mobile device 36 may also include an antenna 36(a) for wireless data transfer (e.g., data transmission).

FIG. 11 shows an example of a payment device 32″ in the form of a card. As shown, the payment device 32″ comprises a plastic substrate 32(m). In some embodiments, a contactless element 32(o) for interfacing with an access device 34 may be present on, or embedded within, the plastic substrate 32(m). Consumer information 32(p) such as an account number, expiration date, and/or a user name may be printed or embossed on the card. A magnetic stripe 32(n) may also be on the plastic substrate 32(m). In some embodiments, the payment device 32″ may comprise a microprocessor and/or memory chips with user data stored in them, e.g., the systems environment and list of AIDs as described above with respect to FIGS. 7 and 8.

As noted above and shown in FIG. 11, the payment device 32″ may include both a magnetic stripe 32(n) and a contactless element 32(o). In some embodiments, both the magnetic stripe 32(n) and the contactless element 32(o) may be in the payment device 32″. In some embodiments, either the magnetic stripe 32(n) or the contactless element 32(o) may be present in the payment device 32″.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

What is claimed is:

1. A method comprising:
receiving payment information from a payment device for a transaction;
identifying one or more routing options for the transaction based on the payment information;
selecting a preferred routing option; and
routing the transaction according to the selected routing option.

2. The method of claim 1, wherein the transaction is a debit transaction.

3. The method of claim 1 wherein identifying one or more routing options comprises comparing a list of application identifiers (AIDs) corresponding to routing options on the payment device to a list of AIDs corresponding to routing options on an access device to determine one or more mutually supported routing options.

4. The method of claim 3 wherein the payment device is a mobile device.

5. The method of claim 3 wherein selecting a preferred routing option comprises applying merchant routing preferences to the one or more mutually supported routing options.

6. The method of claim 1 wherein receiving payment information from a payment device further comprises:
displaying, for each routing option, an application label associated with that routing option; and
receiving a selection of one or more application labels.

7. The method of claim 6 wherein the selection of one or more application labels indicates a consumer routing preference.

8. A method comprising:
receiving payment information from a contactless payment device for a transaction;
executing a pre-selection phase to determine a preferred application identifier and associated routing option based on the payment information; and
completing the transaction using the preferred application identifier and associated routing option.

9. The method of claim 8 wherein executing a pre-selection phase to determine a preferred application identifier and associated routing option based on the payment information comprises:
determining that the list of one or more application identifiers includes a single application identifier; and
routing the transaction using a routing option corresponding to the single application identifier.

10. The method of claim 8 wherein executing a pre-selection phase to determine a preferred application identifier and associated routing option based on the payment information comprises:
reading a list of one or more application identifiers stored on the contactless payment device; and
determining a priority for each of the one or more application identifiers.

11. The method of claim 10 further comprising:
determining a highest priority application identifier;
comparing the highest priority application identifier to a merchant list of supported application identifiers; and
routing the transaction according to a routing option associated with the highest priority application identifier if the highest priority application identifier matches a preferred application identifier from the merchant list.

12. The method of claim 10 further comprising:
determining that a highest priority application identifier is eligible for alternative routing;
displaying a plurality of routing options to a consumer;
receiving a selection of a routing option; and
routing the transaction according to the selected routing option.

13. The method of claim 12 wherein determining that a highest priority application identifier is eligible for alternative routing comprises:
determining that the highest priority application identifier is a debit application identifier.

14. The method of claim 12 wherein routing the transaction according to the selected routing option comprises:
removing from a merchant list of supported application identifiers all of the supported application identifiers except an application identifier associated with the selected routing option;
prompting the consumer to re-present the contactless payment device; and
routing the transaction according to the selected routing option.

15. The method of claim 10 further comprising:
determining that the list of one or more application identifiers includes a merchant preferred application identifier;
determining a bank identification number (BIN) associated each application identifier in the list of one or more application identifiers that has a higher priority than the merchant preferred application identifier;
comparing each BIN to a merchant preferred BIN associated with the merchant preferred application identifier;
if the merchant preferred BIN matches each BIN, then routing the transaction using the merchant preferred application identifier; and
if the merchant preferred BIN does not match each BIN, then routing the transaction using a highest priority application identifier from the list of one or more application identifiers.

16. The method of claim 15 further comprising:
providing an indication of how the transaction was routed to the consumer.

17. An access device, comprising:
a processor, and a computer readable medium coupled to the processor;
a merchant list of application identifiers stored on the computer readable medium, wherein the merchant list of application identifiers includes one or more application identifiers that correspond to routing options supported by a merchant;
merchant routing preferences that define a priority associated with each of the one or more application identifiers;
a contactless element, wherein when payment information is received from a contactless payment device, the processor is configured to
execute a pre-selection phase to determine a preferred application identifier and routing option based on the payment information and the routing preferences, and
complete a transaction using the preferred application identifier and routing option.

18. The access device of claim 17 wherein the pre-selection phase includes:
reading a consumer list of application identifiers stored on the contactless payment device; and
determining a priority for each application identifier in the consumer list.

19. The access device of claim 18 wherein the pre-selection phase further includes:
determining a highest priority application identifier;
comparing the highest priority application identifier to a merchant list of supported application identifiers; and
routing the transaction according to a routing option associated with the highest priority application identifier if the highest priority application identifier matches a preferred application identifier from the merchant list.

20. The access device of claim 18 wherein the pre-selection phase further includes:
determining that a highest priority application identifier is eligible for alternative routing;
displaying a plurality of routing options to a consumer;
receiving a selection of a routing option; and
routing the transaction according to the selected routing option.

21. The access device of claim 20 wherein determining that a highest priority application identifier is eligible for alternative routing comprises:
determining that the highest priority application identifier is a debit application identifier.

22. The access device of claim 20 wherein routing the transaction according to the selected routing option comprises:
removing from the merchant list of supported application identifiers all of the supported application identifiers except an application identifier associated with the selected routing option;
prompting the consumer to re-present the contactless payment device; and
routing the transaction according to the selected routing option.

23. The access device of claim 18 wherein the pre-selection phase further comprises:
determining that the list of one or more application identifiers includes a merchant preferred application identifier;
determining a bank identification number (BIN) associated each application identifier in the list of one or more application identifiers that has a higher priority than the merchant preferred application identifier;
comparing each BIN to a merchant preferred BIN associated with the merchant preferred application identifier;
if the merchant preferred BIN matches each BIN, then routing the transaction using the merchant preferred application identifier; and
if the merchant preferred BIN does not match each BIN, then routing the transaction using a highest priority application identifier from the list of one or more application identifiers.

24. The method of claim 23 wherein the pre-selection phase further comprises providing an indication of how the transaction was routed to the consumer.
